(19) United States
(12) Patent Application Publication
(10) Pub. No.: US 2024/0195096 A1
(43) Pub. Date: Jun. 13, 2024

(54) TRANSMISSION CABLE AND TERMINAL CONNECTOR

(71) Applicant: ELKA INTERNATIONAL LTD., New Taipei City (TW)

(72) Inventors: Yi-Chieh CHENG, New Taipei City (TW); Jui-Ming YANG, New Taipei City (TW); Chang-I CHEN, New Taipei City (TW)

(73) Assignee: ELKA INTERNATIONAL LTD., New Taipei City (TW)

(21) Appl. No.: 18/198,086

(22) Filed: May 16, 2023

(30) Foreign Application Priority Data
Dec. 8, 2022 (TW) 111213597

(51) Int. Cl. H01R 12/71; H01R 12/57

(52) U.S. Cl. CPC H01R 12/718; H01R 12/57; H01R 2201/16

(57) ABSTRACT

A transmission cable includes a terminal connector and a line set. The terminal connector includes a circuit board and a setting head having a power terminal, a grounding terminal, and a first signal terminal. The line set includes a signal transmission unit having a first signal transmission part and a drain wire. The first signal transmission part is electrically coupled to the first signal terminal via the circuit board, and the drain wire is electrically connected to the power terminal via the circuit board.

### FIELD OF THE INVENTION

The disclosure relates to a transmission cable and a terminal connector. Specifically, the disclosure relates to a transmission cable and terminal connector for long-distance transmission.

### BACKGROUND OF THE INVENTION

With the progress of technology, physical transmission cables are essential and irreplaceable for transmitting audio and video signals or high-frequency signals. Referring to FIG. 1, FIG. 1 illustrates a conventional configuration of the physical transmission cable P10. The transmission cable P10 includes a power transmission line P12 coupled to the power terminal (Power) of the setting heads P11 at both ends, a signal transmission line P13 (for example, twisted pair) configured to transmit signals, an anti-noise part P14 (for example, a drain wire) coupled to the ground terminal (GND), and ground wire(s) and/or a braid layer P15 connected to the ground terminal. It should be noted that the anti-noise part P14 is different from the ground wire(s) and/or the braid layer P15. The ground wire(s) and/or the braid layer P15 are located at the outer layer of the cable portion of the transmission cable P10 and preferably grounded with the metal housing of the setting head P11 to prevent noise from outside of the transmission cable P10 from coupling to the signal transmission line P13 in the transmission cable P10. On the other hand, the function of the anti-noise part P14 is, for example, to eliminate and/or drain the interference signal of the signal transmission line P13. Therefore, compared to wireless transmission, transmission through the physical transmission cable has the advantages of fast transmission speed, stable transmission quality, and/or less susceptible to noise.

However, the physical transmission cable is limited by physical limitations. For example, the resistance/impedance of the cable portion (line set) of the transmission cable will cause power consumption, resulting in a voltage drop between two ends. The voltage drop will cause signal level offset or misalignment, resulting in loss of function or malfunction.

Conventionally, the power consumption problem caused by the electrical resistance/impedance of the transmission cable can be solved/overcome by increasing the diameter of the transmission cable. For example, according to regulations or specifications, the voltage drop between the two ends of the transmission cable P10 must be less than 500 mV, or the voltage difference between the two ends of the transmission cable P10 must be less than 5-10%. The voltage drop or the voltage difference can be reduced or relieved by increasing the wire diameter of the power transmission line P12. However, through the above adjustment methods, the hardness of the transmission cable P10 will also be increased. After increasing the wire diameter. The transmission cable may be too thick to comply with various regulatory specifications of transmission connectors (such as HDMI) or increase the product costs of the transmission cable P10. The transmission cables P10 that is stiff will have problems such as difficulty in bending and make the P10 difficult for users/installers to set up.

It should be noted that the voltage drop problem is not only related to long-distance transmission. For short-distance transmission applications, if using a transmission cable with a smaller cross-sectional area (line diameter) to transmit signals, the smaller cross-sectional area cable will achieve advantages such as reduced cable costs and improved wire flexibility.

Therefore, under the premise of not increasing the diameter of the transmission cable or of reducing the line diameter of the transmission line, how to reduce the signal attenuation and/or the power consumption caused by the impedance/resistance of the transmission cable will be a significant topic(s) in the research and development of transmission cable.

### SUMMARY OF THE INVENTION

One of the purposes of the disclosure is to reduce the voltage drop (or voltage difference) between the two ends of the transmission cable.

One of the purposes of the disclosure is to reduce the signal attenuation and/or power consumption caused by the impedance/resistance of the transmission cable.

In an embodiment, a transmission cable includes a terminal connector and a line set. The terminal connector includes a circuit board and a setting head with a power terminal, a grounding terminal, and a first signal terminal. The line set includes a signal transmission unit with a first signal transmission part and a drain wire, the first signal transmission part electrically coupled to the first signal terminal via the circuit board, and the drain wire electrically connected to the power terminal via the circuit board.

In an embodiment, a transmission cable comprises a terminal connector and a line set. The terminal connector includes a circuit board and a setting head having a power terminal, a grounding terminal, and a signal terminal. The line set includes a signal transmission unit having a signal transmission part electrically coupled to the signal terminal via the circuit board and a conductor layer at least partly covering the signal transmission part and electrically coupled to the power terminal.

In an embodiment, a terminal connector comprises a setting head and a circuit board. The setting head has a power terminal, a grounding terminal, and a signal terminal. The circuit board is configured to connect the setting head and a line set, wherein the circuit board includes a first power pad configured to electrically couple an anti-noise part of the line set to the power terminal.

As mentioned above, although the power transmission unit (e.g., the cable/wire for power transmission) in the line set can be used as the main carrier for transmitting power, the diameter of the power transmission unit cannot be unlimitedly increased for long-distance transmission. Accordingly, the voltage drop and/or the energy attenuation of the transmission cable can be mitigated. On the other hand, people would like to reduce the cross-sectional area of the power transmission unit to improve the practicality of the transmission cable. By coupling at least a portion of the anti-noise portion of the signal transmission unit in the line set to the power supply terminal, the anti-noise portion electrically coupled to the power supply terminal can serve as a sub-carrier for the power supply signal, so the diameter of the power transmission unit is not necessarily increased or even can be reduced.

### BRIEF DESCRIPTION OF THE DRAWINGS

The accompanying drawings are presented to aid in the description of various aspects of the disclosure and are provided solely for illustration of the aspects. In order to simplify the drawings and highlight the contents to be presented in the drawings, the well-known structures or elements in the drawings may be drawn in a simple schematic manner or presented in an omitted manner. For example, the number of elements may be singular or plural. These drawings are provided only to explain these aspects and not to limit thereof.

FIG. 1 is a conventional configuration diagram of a conventional transmission cable.

FIG. 2A illustrates an exploded terminal connector diagram according to the disclosure's first embodiment.

FIG. 2B illustrates a schematic diagram of the terminal connector according to the first embodiment of the disclosure.

FIG. 3 illustrates a structural diagram of the transmission cable according to a second embodiment of the disclosure.

FIG. 4 is a schematic diagram of the second embodiment of the disclosure, wherein the drain wire is coupled to the power terminal.

FIG. 5 illustrates a structural diagram of the transmission cable according to a fifth embodiment of the disclosure.

FIG. 6 is a schematic diagram of the fifth embodiment of the disclosure, wherein the conductor layer is coupled to the power supply terminal.

FIGS. 7A and 7B are schematic diagrams of the pad arrangement according to the fifth embodiment of the disclosure.

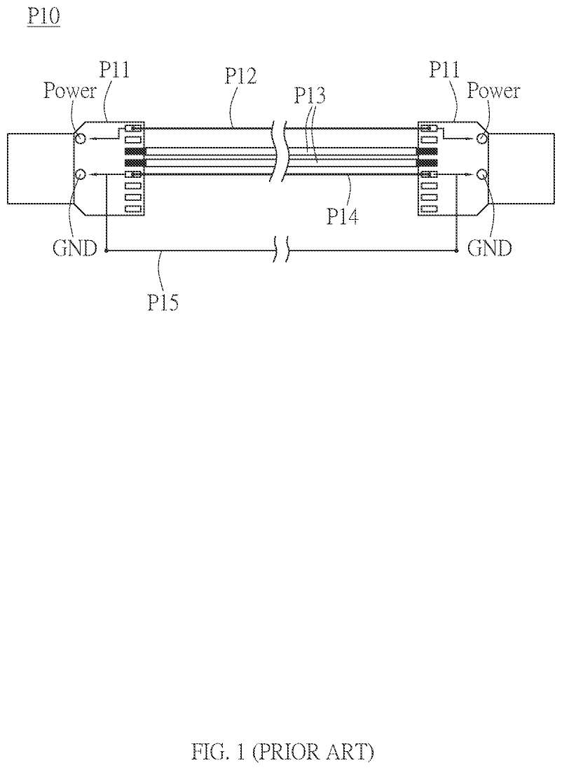

### DETAILED DESCRIPTION OF THE PREFERRED EMBODIMENTS

Even though the terms such as “first”, “second”, and “third” may be used to describe an element, a part, a region, a layer, and/or a portion in the present specification, these elements, parts, regions, layers and/or portions are not limited by such terms. Such terms are used to differentiate an element, a part, a region, a layer, and/or a portion from another element, part, region, layer, and/or portion. Therefore, in the following discussions, a first element, portion, region, or portion may be called a second element, portion, region, layer, or portion, and do not depart from the teaching of the present disclosure. The terms “comprise,” “include”, or “have” used in the present specification are open-ended terms and mean to “include”, but not limit to

As used herein, the term “coupled to” in the various tenses of the verb “couple” may mean that element A is directly connected to element B or that other elements may be connected between elements A and B (i.e., that element A is indirectly connected with element B).

The terms “approximate,” or “essentially” used in the present specification include the value itself and the average values within the acceptable range of deviation of the specific values confirmed by a person having ordinary skill in the current art, considering the specific measurement discussed and the number of errors related to such measurement (that is, the limitation of the measurement system). For example. “about” may mean within one or more standard deviations of the value itself or ±30%, ±20%, ±10%, ±5%. In addition, “about”, “approximate”, or “essentially” used in the present specification may select a more acceptable range of deviation or standard deviation based on optical property, etching property, or other properties. One cannot apply one standard deviation to all properties.

It should be noted that the “setting head” can be a plug or socket. A plug refers to, for example, a male device such as male connectors, pins, or means configured to be inserted into a setting structure. On the other hand, a socket refers to, for example, a female device such as female connectors, slots, or needle base or means configured to receive a male device. Usually, people skilled in the art will know that the male and female devices in this disclosure can equivalently exchange without affecting the effect of this disclosure. In the figures of the disclosure, one of the male and female devices will be used as an explanation, but it is not intended to limit the “setting head” in the disclosure.

### First Embodiment

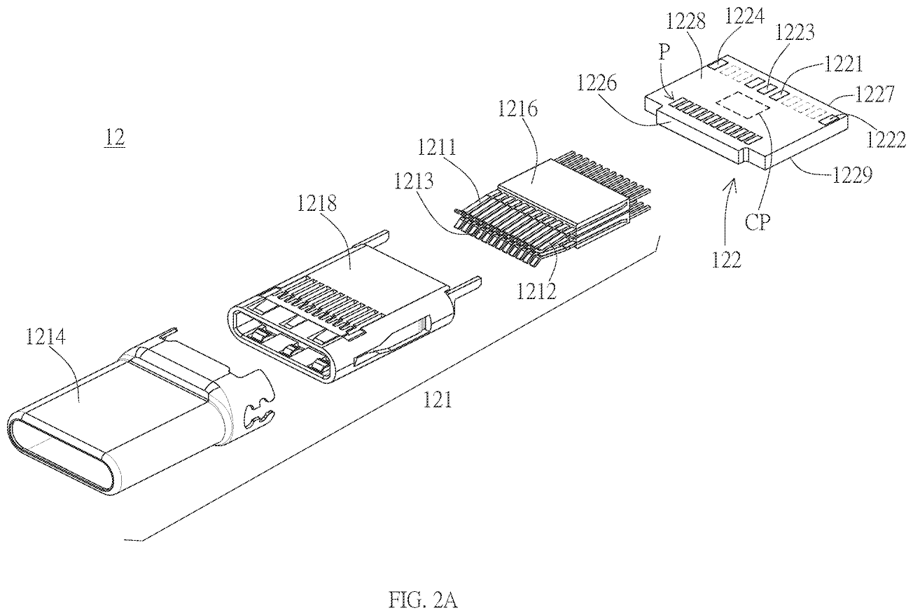

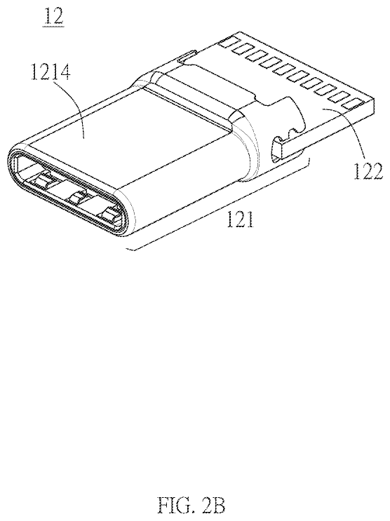

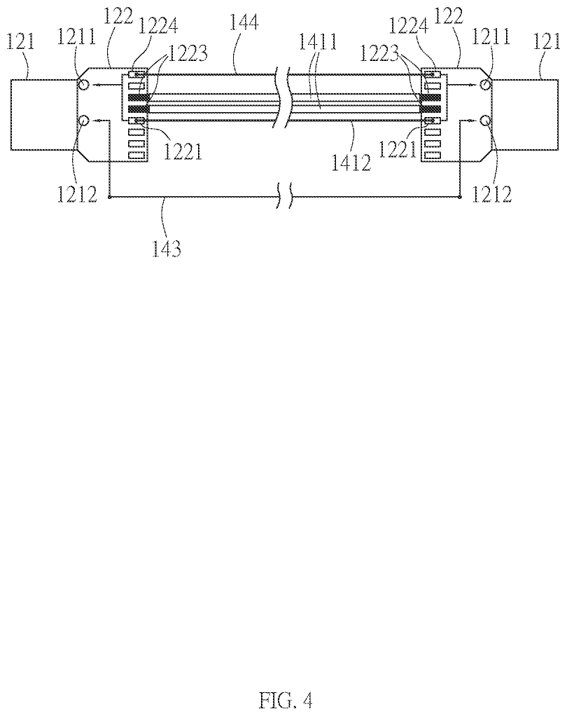

Referring to FIGS. 2A and 2B. FIG. 2A illustrates an exploded diagram of terminal connector 12 according to the first embodiment of the disclosure. The terminal connector 12 includes a setting head 121 and a circuit board 122 configured to connect the setting head 121, and a line set (not shown in FIG. 2A). The setting head 121 has a power terminal 1211, a grounding terminal 1212 and a signal terminal 1213. The circuit board 122 includes a first power pad 1221 configured to connect the anti-noise part (for example, drain wire(s) or the outer conductor layer of a coaxial cable) of the signal transmission unit (such as 144 shown in FIG. 3 or 244 shown in FIG. 5) arranged in the line set to the power terminal 1211.

More specifically, the specification of the setting head 121 can be a connector of any regular specification and have corresponding housing 1214. The connector of the regular specification can be, for example, a connector of HDMI, Display port (DP), USB (type-A/type-C), or any other conventional specifications for transmitting signal. The housing 1214 is but is not limited to, preferably, electrically coupled to the grounding terminal 1212. The housing 1214 can be a protective structure to provide physical protection for terminals in the setting head 121 or a foolproof mechanism while inserting the setting head 121 into a corresponding socket. For example, the structure or shape of housing 1214 can be formed corresponding to the setting site to avoid inserting the wrong location or setting in the wrong direction during setting head 121. The power terminal 1211, the grounding terminal 1212, and the first signal terminal 1213 can be integrated by rack 1216. As shown in FIG. 2B, the housing 1214 can be configured to cover the shell 1218, the rack 1216, and terminals 1211, 1212, and 1213 to provide physical protection or electrical protection to terminals 1211, 1212, and 1213.

The circuit board 122 can be a printed circuit board (PCB) or any proper circuit carrier. The circuit board 122 can be configured to connect with the setting head 121 according to the specification of the setting head 121. For example, various contact pads (P) can be arranged on surface 1228 of the circuit board 122 adjacent to side 1226 of the circuit board 122. The contact pads (P) can be electrically coupled to terminals (for example, the power terminal 1211, the grounding terminal 1212, and/or the first signal terminal 1213) on the setting head 121 by a pin, welding, wiring, or other connecting methods. Then, through the preset trace layout on the circuit board 122, the power terminal 1211 is electrically coupled to the first power pad 1221, the grounding terminal 1212 is electrically coupled to the grounding pad 1222, and/or the first signal terminal 1213 is electrically coupled to the first signal pad 1223. It should be noted that the connecting methods are examples, and the disclosure does not limit the means for connecting the power terminal 1211, the grounding terminal 1212, and the first signal terminal 1213 to the first power pad 1221, the grounding pad 1222 and the first signal pad 1223 on the circuit board 122. Although the trace layout on circuit board 122 is not shown in the disclosure figures, people skilled in the art can use any suitable means to generate a proper trace layout on the conductor portion of the circuit board 122 to implement the first embodiment.

Pads (for example, the first power pad 1221, the grounding pad 1222, and the first signal pad 1223) can be arranged on the surface 1228 of the circuit board 122 adjacent to the side 1227 away from the setting head 121. It should be noted that the number, relative position, spacing, shape, and/or size of pads are illustrated in FIGS. 2A and 2B are examples only and are not intended to limit the disclosure. More specifically, the number, spacing, shape, and/or size of pads arranged on the surface 1228 of the circuit board 122 adjacent to the second side 1227 can be determined based on the number and/or type of wires in the corresponding line set. In addition, the contact pads and/or traces can be arranged on both surface 1228 and the back surface 1229 of the circuit board 122

It should be noted that the contact pads can be referred to as connecting pads, pads, or any components with the same or similar functions. The circuit layout of the circuit board 122 can be modified based on the physical size of the circuit board 122 and the physical size of the corresponding setting head 121. For example, the pads for connecting lines belonging to the same twisted pair or line group can be arranged adjacent to each other. More specifically, the first power pad 1221 configured to couple to the anti-noise part of the line set electrically, and the first signal pad 1223 configured to electrically couple to the signal transmission unit of the line set is preferably arranged adjacent to each other. Therefore, the interference during wire welding will be reduced, and the wiring path will be clearer and more concise.

In the first embodiment, the chip arranging area (CP) for arranging active transmission chips can be preserved on circuit board 122. It should be noted that the chip arranging area (CA) can be preserved on one or two sides (surface 1228 and/or back surface 1229) of the circuit board 122. The active transmission chip can be used for adjusting/regulating (for example, amplifying, converting, or switching) the signals received/transmitted by the first signal terminal 1213 via the signal transmission unit of the line set. More specifically, the terminal connector 12 (with/without the active transmission chip) can be arranged at one or two ends of the line set. It is noted that the line set may have the same or different specifications corresponding to the terminal connector 12. When the specification of terminal connectors arranged at two ends of the line set are different, the active transmission chip can be used to convert the signal between different protocols (for example, USB/HDMI or HDMI/DP). When the amplitude of the transmitted signal is insufficient, the active transmission chip can be used to amplify the transmitted signal. However, the effect of setting the active transmission chip in this disclosure is not limited to the embodiment. The disclosure is also applicable to the passive transmission cable architecture (i.e., no active transmission chip).

### Second Embodiment

In the second embodiment, the transmission cable includes the terminal connector and the line set. The terminal connector includes the circuit board and the setting head having the power terminal, the grounding terminal, and the first signal terminal. The line set includes the signal transmission unit having the first signal transmission part and the drain wire. The first signal transmission part is electrically coupled to the first signal terminal via the circuit board. The drain wire is electrically connected to the power terminal via the circuit board. The disclosure does not limit the means for electrically coupling the line set to the setting head via the circuit board.

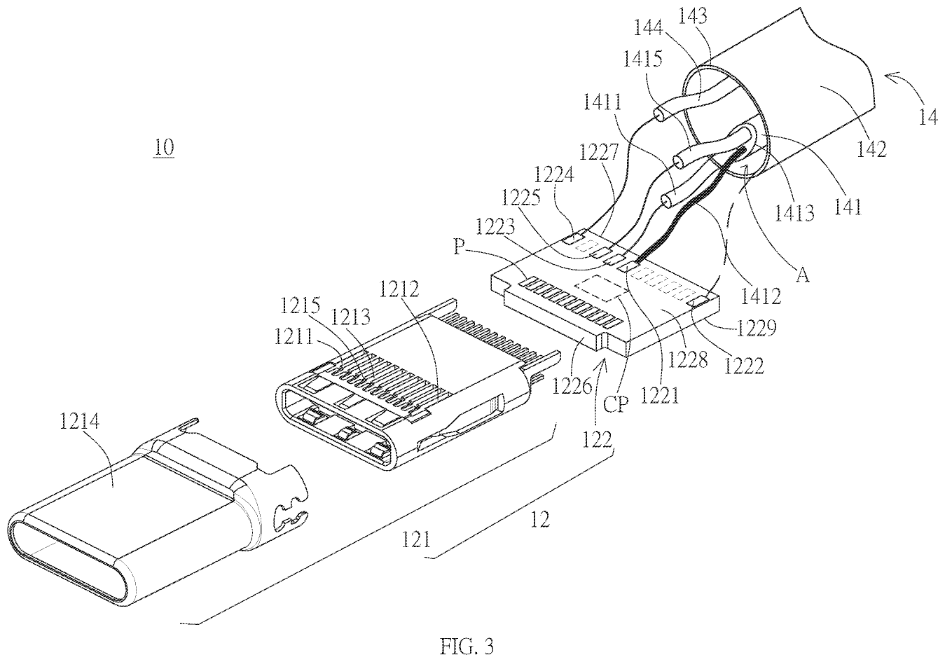

An example of coupling the line set to the setting head via the circuit board is shown in FIGS. 3 and 4. FIG. 3 illustrates an exemplary structural diagram of the transmission cable 10 according to the second embodiment. In this embodiment, transmission cable 10 includes a terminal connector 12 and line set 14. The terminal connector 12 includes the setting head 121 and the circuit board 122. The setting head 121 has the power terminal 1211, the grounding terminal 1212, and the first signal terminal 1213. Circuit board 122 has the first power pad 1221 electrically coupled to the power terminal 1211, the grounding pad 1222 electrically coupled to the grounding terminal 1212, and the first signal pad 1223 electrically coupled to the first signal terminal 1213. Line set 14 includes a signal transmission unit 141. The signal transmission unit 141 includes a first signal transmission part 1411 and a drain wire 1412. A portion of the first signal transmission part 1411 is arranged on the first signal pad 1223, and the first signal transmission part 1411 is electrically coupled to the first signal terminal 1213 via the pads and trace on the circuit board 122. Similarly, a portion of the drain wire 1412 is arranged on the first power pad 1221, and the drain wire 1412 is electrically coupled to the power terminal 1211 via pads and trace on the circuit board 122.

More specifically, line set 14 is formed, for example, by grouping various lines, wires, and/or cables (for example, single core wire, coaxial line, twisted pair, multi-stranded wire) and covering the grouped lines, wires, and/or cables by an insulation layer 142. It should be noted that line set 14 does not limit the number or type of wires (core wires) in the line set. Preferably, the core wires can be selected according to the specification of the setting head 121, but not limited thereto. It should be noted that line set 14 can further include another line (s) or layer(s).

In the second embodiment, line set 14 further includes a shielding layer 143, which partly covers the signal transmission unit 141. For example, the cross-section of the shielding layer 143 is a ring shape, and the accommodation space (A) is formed in the shielding layer 143. The signal transmission unit 141 is arranged in the accommodation space (A). In other words, the signal transmission unit 141 is covered by the shielding laver 143. It should be noted that the accommodation space (A) is shown in FIG. 3 is only a schematic illustration, and the size of accommodation space (A) may be slightly larger than the cross-sectional area of a signal transmission unit 141 due to the tight covering of shielding layer 143 on signal transmission unit 141. In addition, the shielding layer 143 is electrically coupled to grounding terminal 1212 (e.g., through grounding pad 1222).

It should be noted that the arranging position of the grounding pad 1222 is not limited to the position shown in FIG. 3. The grounding pad 1222 can be disposed of on the surface 1228 or the back surface 1229 of the circuit board 122. In this second embodiment, the shielding layer 143 can be coupled to the external housing 1214 or other electrically grounded parts to make the potential of the shielding layer 143 as a ground point. More specifically, the shielding layer 143 is a conductor such as aluminum foil or copper mesh arranged in the outer layer of line set 14. For example, when the profile of line set 14 is circular, the outermost layer can be insulating layer 142, followed by shielding layer 143, but not limited thereto. The shielding layer 143 is electrically coupled to the grounding terminal 1212 through the grounding pad 1222. The grounded shielding layer 143 has the function of shielding the external noise outside line set 14 from interfering with the signal transmission inside line set 14.

In this second embodiment, line set 14 can further include a power transmission unit 144, which is electrically coupled to the power terminal 1211 via the second power pad 1224 arranged on the circuit board 122. For example, the power transmission unit 144 is a wire (e.g., copper wire) that transmits power in line set 14. The power transmission unit 144 can serve as a main carrier for power transmission to the transmission cable 10. It should be noted that both the first power pad 1221 and the second power pad 1224 are arranged on circuit board 122 and are electrically coupled to the power terminal 1211 through, for example, the preset traces formed on circuit board 122. The disclosure is not limited to the number or size of pads coupled to the power terminal 1211. For example, the first power pad 1221 and the second power pad 1224 can be integrated into a single pad (larger or equal to the size of the first power pad 1221 and/or the second power pad 1224) or divided into more pads for connecting with the drain wire 1412 and the power transmission unit 144. Therefore, the interference of welding can be reduced, or when there are other lines of the line set that need to be coupled to the power terminal 1211, adjustments can be made for welding and assembly.

In this second embodiment, the signal transmission unit 141 has the first signal transmission part 1411 and the drain wire 1412 (i.e., the anti-noise part of the signal transmission unit 141). Preferably, the signal transmission unit 141 may further have a second signal transmission part 1415. More specifically, the first signal transmission part 1411 can be twisted in pair with the second signal transmission part 1415 configured to transmit differential signals. The first signal transmission part 1411 can be electrically coupled to the first signal pad 1223 and the first signal terminal 1213. The second signal transmission part 1415 can be electrically coupled to the second signal pad 1225 adjacent to the first signal pad 1223 and the second signal terminal 1215. It is noted that when the signal transmission part 1411 is formed by a single wire or multiple wires, the circuit board 122 is formed with a corresponding number of pad(s) for the signal transmission part(s) of the signal transmission unit 141 to transmit the required signal(s).

Referring to FIG. 4, FIG. 4 is a schematic diagram of the drain wire 1412 coupled to power terminal 1211 and the shielding layer 143 coupled to grounding terminal 1212. It should be noted that the difference between the drain wire 1412 of the signal transmission unit 141 and the shielding layer 143 is that the shielding layer 143 is arranged at the outer layer of the line set 14 (for example, the copper mesh arranged at the outer layer of the line set 14). The shielding layer 143 is coupled to the grounding terminal 1212. Therefore, the shielding layer 143 is configured to prevent noise from outside of line set 14 from coupling to a signal transmission unit 141 or other units inside line set 14. Compared with the shielding layer 143, the exemplary function of the drain wire 1412 is to exclude and/or drain interference signals from the signal transmission part 1411. The interference signal of the signal transmission part 1411 can be noise generated by the interaction of the signal transmission part 1411 (e.g., crosstalk noise, etc.) or noise coupled from outside of the signal transmission part 1411. The drain wire 1412 is electrically coupled to the first power pad 1221 so that the drain wire 1412 can be used to transmit a portion of the power signal (for example, DC 5V). Hence, the wire diameter of the power transmission unit 144 can be reduced. More specifically, in the DC transmission, drain wire 1412 will be used as a second power transmission unit. The power transmitted via the power transmission unit 144 can be reduced with the second power transmission unit. Therefore, the wire diameter of the power transmission unit 144 can be reduced. For example, depending on the transmission distance, the cross-sectional area thereof can be reduced from 0.5 mm² to 0.2 mm² or from 0.12 mm² to 0.05 mm². Compared with conventional configurations, the disclosure configuration can optimize wire diameter selection for the power transmission unit 144. For example, the range for the power transmission unit 144 can be optimized or reduced from wire gauges AWG20 to AWG28 to wire gauges AWG22 to AWG30. In other words, compared with conventional configurations, under the same length requirements, the wire gauge that can be selected for the configuration of the disclosure can be reduced by at least 2 levels (in AWG units).

It should be noted that although the description is based on AWG as the wire diameter unit, similar or equivalent units should still be included in the scope of the disclosure. When the transmission cable transmits high-frequency (e.g., above 1 GHz) signals, the drain w % ire 1412 can still perform its original functions, such as excluding interference signals on the first signal transmission part 1411 and/or the second signal transmission part 1415 from the power terminal 1211 and/or grounding terminal 1212. Therefore, it is possible to increase the transmission efficiency of the power transmission unit without affecting the grounding efficiency (or to a very small extent) to at least achieve the effect of reducing the voltage drop.

In the second embodiment, the drain wire 1412 can be bare (i.e., without being covered by an insulating layer) arranged adjacent to the first signal transmission part 1411. In a preferred arrangement, the signal transmission unit 141 can have a cladding layer 1413 that at least partially covers the first signal transmission part 1411 and the drain wire 1412. The material of the cladding layer 1413 can be insulated (e.g., mylar), a conductive material (e.g., aluminum foil or tin foil), or a composite layer of conductive/insulating material. The drain wire 1412 and the first signal transmission part 1411 are tightly covered by the cladding layer 1413. However, the configuration of the drain wire 1412 is not limited to the above examples.

### Third Embodiment

in the third embodiment (not shown), the line set can contain multiple signal transmission units, and each of the signal transmission units has its drain wire. For example, the line set for HDMI terminal connector will contain four sets of signal transmission units. Each set of signal transmission units has at least one drain wire. However, it is not necessary to couple every drain wire to the power terminal. In other words, to implement the configuration of the disclosure, only one or more than one of the drain wires can be electrically coupled to the power terminal. The remaining drain wire(s) that is not coupled to the power terminal will be electrically coupled to the grounding terminal. More specifically, referring to Table 1, Table 1 takes the case where the line set includes four sets of signal transmission units, and each of the four sets of signal transmission units has a drain wire (drain wire 1 to drain wire 4) as an example. In Table 1, “GND” represents the electrical coupling to the grounding terminal, and “Power” represents the electrical coupling to the power terminal. The second row of Table 1 shows the impedance/resistance of the prior art configuration (i.e., drain wire 1 to drain wire 4 are coupled to the grounding terminal) as the reference value (i.e., 100%). The third to sixth rows of Table 1 represent configurations 2 to 5 of the disclosure. In other words, at least one of the drain wires, 1 to 4, is electrically coupled to the power terminal. As shown in Table 1, the impedance of configurations 2 to 5 is effectively reduced (by at least 50% to 75%) compared to the conventional configuration. Accordingly, configurations 2 to 5 can be selected according to, for example, the length requirements of transmission cables, the number of drain wires, and/or the anti-interference requirements.

TABLE l
Reduced impedance due to different configurations

| | Drain | Drain | Drain | Drain | |
|---|---|---|---|---|---|
| Configurations | wire 1 | wire 2 | wire 3 | wire 4 | Impedance |
| 1(prior art) | GND | GND | GND | GND | 100% |
| 2 | Power | GND | GND | GND | 50% |
| 3 | Power | Power | GND | GND | 33% |
| 4 | Power | Power | Power | GND | 25% |
| 5 | Power | Power | Power | Power | 20% |

It should be noted that the values in Table 1 are only used to illustrate the embodiment, not to limit it. The amount of impedance variation among different configurations may vary depending on factors such as the measurement method, types and/or materials of the line set, or connection means. Moreover, the number of drain wires in the disclosure is not limited to the above embodiment.

### Fourth Embodiment

The fourth embodiment illustrates the relationship between the length of the transmission cable and the voltage drop. Referring to Table 2, it can be understood that there is a voltage difference between the voltage (5V) of the output terminal (e.g., a computer or set-top box) of the transmission cable (e.g., an HDMI transmission cable) and the voltage of the receiving terminal (such as a display, TV or monitor). It should be noted that, in Table 2, the voltage differences between transmission cables of different lengths may not be comparable to each other due to different configurations of the transmission cables themselves (for example, different wire diameters). However, after being electrically coupled to the power terminal through the drain wire, the impedance of the power transmission cable can be compensated or reduced, effectively reducing the voltage drop across the cable. For example, when the transmission cable length is 12 meters, the voltage difference between the two ends of the conventional configuration is 0.905 V. In the configuration of the disclosure (taking configuration 5 in the third embodiment as an example), the voltage difference between the two ends is 0.209 V. It should be noted that the measurement data in Table 2 only illustrate the length of the transmission cable and the optimization trend of a voltage drop across different configurations, and is not intended to limit the disclosure. The measurement data in Table 2 may vary due to factors such as output power (i.e., the amount of current at a constant voltage), measurement methods, types and/or materials of the line set, or connection means.

TABLE 2
Relationship between line set length and voltage drop
Output terminal voltage (5 V)

| | Prior art | | The disclosure | |
|---|---|---|---|---|
| | Terminal | Voltage | Terminal | Voltage |
| Length (M) | voltage (V) | drop (V) | voltage (V) | drop (V) |
| 7.5 | 3.676 | 1.324 | 4.675 | 0.325 |
| 9 | 3.984 | 1.016 | 4.802 | 0.198 |
| 12 | 4.095 | 0.905 | 4.791 | 0.209 |

### Fifth Embodiment

In the fifth embodiment, the transmission cable includes a terminal connector and a line set. The terminal connector includes a circuit board and a setting head having a power terminal, a grounding terminal, and a signal terminal. The line set includes a signal transmission unit having a signal transmission part and a conductor layer. The signal transmission part is electrically coupled to the signal terminal via the circuit board. The conductor layer is at least partly covered by the signal transmission part and electrically coupled to the power terminal. The disclosure does not limit the means for electrically coupling the line set to the setting head via the circuit board.

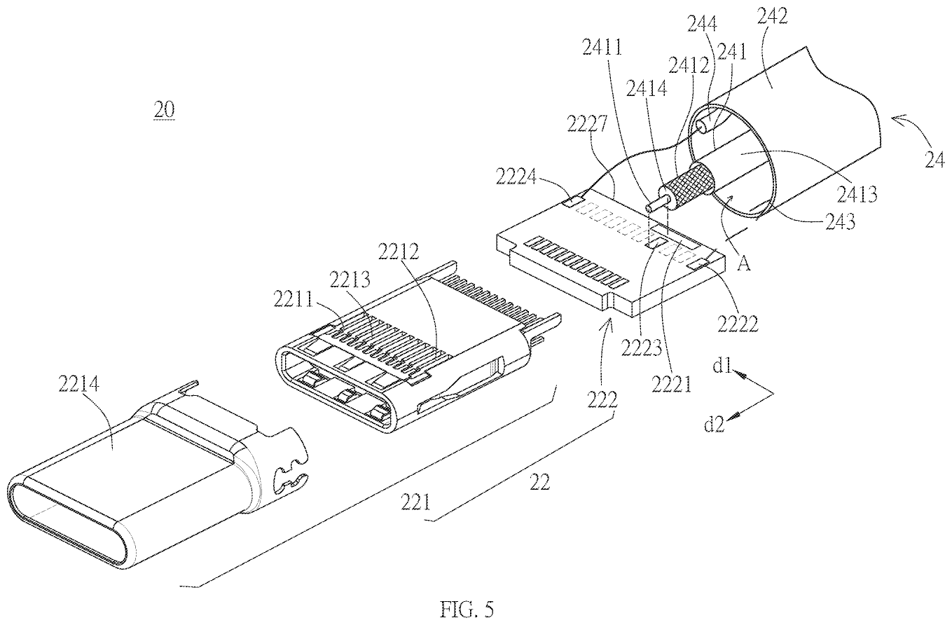

An example of coupling the line set to the setting head via the circuit board is shown in FIGS. 5 and 6. Referring to FIGS. 5 and 6, transmission cable 20 includes a terminal connector 22 and a line set 24. The terminal connector 22 includes a setting head 221 and a circuit board 222. The setting head 221 has a power terminal 2211, a grounding terminal 2212, and a signal terminal 2213. The circuit board 222 has a first power pad 2221 electrically coupled to the power terminal 2211, a grounding pad 2222 electrically coupled to the grounding terminal 2212, and a signal pad 2223 electrically coupled to the signal terminal 2213. Line set 24 includes a signal transmission unit 241. The signal transmission unit 241 has a signal transmission part 2411 and a conductor layer 2412 (i.e., the anti-noise part). The signal transmission part 2411 is electrically coupled to the signal pad 2223. The conductor layer 2412 at least partly covers the signal transmission part 2411 and is configured to use as an anti-noise part of the signal transmission unit 241.

More specifically, the signal transmission unit 241 may refer to a coaxial line. The signal transmission part 2411 refers to a conductor core in the coaxial line. The conductor layer 2412 refers to an aluminum foil or a copper mesh covering the conductor core in the coaxial line. The second insulating layer, 2414, may be provided between the signal transmission part 2411 and the conductor layer 2412 to prevent electrical conduction between the signal transmission part 2411 and the conductor layer 2412. In addition, the signal transmission unit 241 can further have a first insulating layer 2413, which at least partially covers the signal transmission part 2411 and the conductor layer 2412. The first insulating layer, 2413, is configured to protect the signal transmission part 2411 and the conductor layer 2412 or avoid electrical conduction between the conductor layer 2412 and other conductors. It should be noted that the same/similar parts as in FIG. 2 are not described here.

Similar to the second embodiment, line set 24 can include other lines or layers in this embodiment. As shown in FIG. 5, line set 24 further includes a shielding layer 243 that at least partly covers the signal transmission unit 241. For example, the -a cross-section of the shielding layer 243 has a ring shape to form an accommodation space (A) therein, and the signal transmission unit 241 is provided in the accommodation space (A). The shielding layer 243 is electrically coupled to grounding terminal 2212 (for example, through grounding pad 2222) and is covered by insulating layer 242. Line set 24 may further include a power transmission unit 244 that is electrically coupled to the power terminal 2211 via the second power pad 2224 of the circuit board 222. It is noted that the first power pad 2221, the grounding pad 2222, the first signal pad 2223, the second power pad 2224, and/or other pads can be located on the same or different side of the circuit board 222. It can be modified according to actual line spacing or circuit layout requirements.

In this embodiment, to avoid repetition, the similarities between terminal connector 22 and terminal connector 12 in the previous embodiment are not elaborated. The first power pad 2221 of the circuit board, 222 of the terminal connectors 22, is arranged between the first signal pad 2223 and side 2227 of the circuit board 222 near line set 24. In other words, the first power pad, 2221, and the first signal pad, 2223, are arranged along the second direction, d2. Specifically, the signal transmission unit 241 is, for example, a coaxial line. When setting the signal transmission unit 241, the exposed conductor layer 2412, after peeling off a part of the first insulating layer 2413, can be disposed of on the first power pad 2221 and electrically coupled to the first power pad 2221 (for example, through welding). The part of the signal transmission part 2411 that is not covered by the conductor layer 2412 and the second insulating layer 2414 can be arranged on the signal pad 2223 and electrically coupled to the signal pad 2223. By arranging the first power pad 2221 and the signal pad 2223 along the second direction d2 to correspond to the conductor layers 2412 and the signal transmission part 2411 exposed sequentially along the second direction d2, it is possible to reduce the structural interference during the setup. On the other hand, the area of the first signal pad 2223 can be expanded along the first direction, d1, to achieve advantages such as convenience in welding.

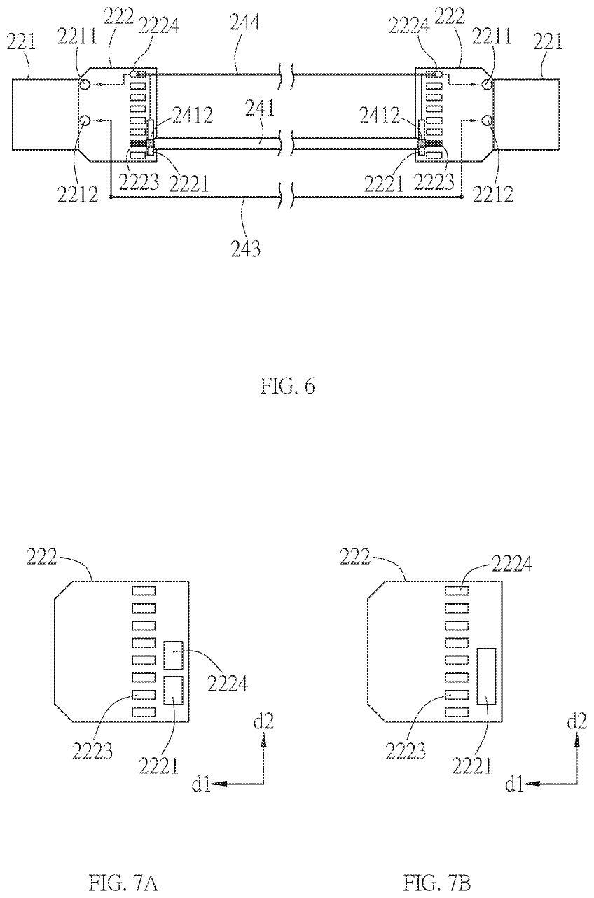

Please refer to FIGS. 7A and 7B. The embodiment is not limited to the setting method of the second power pad 2224. For example, the second power pad 2224 can be directly connected to the first power pad 2221 to form a single pad or disposed of adjacent to the first power pad 2221 alone in the first direction d1. The second power pad, 2224, can be arranged in the same column as the first signal pad, 2223, along the first direction, d1. It should be noted that FIGS. 7A and 7B are only used to illustrate the possible arrangements of the first power pad 2221, the first signal pad 2223, and/or the second power pad 2224 and are not intended to limit the arrangement and relative position of the first power pad 2221, the first signal pad 2223, and/or the second power pad 2224.

In this embodiment, the line set can include multiple sets of coaxial lines. In this embodiment, the conductor layer in at least one of the coaxial lines can be electrically coupled to the power terminal to compensate for the line set's impedance and reduce the line set's power loss. On the other hand, the line set can include multiple sets of coaxial lines and/or twisted pairs. In this embodiment, the conductor laver of at least one of the coaxial lines and/or the drain wire of the twisted pairs can be coupled to the power terminal, the remaining conductor layers of the coaxial lines and/or the remaining drain wires of the twisted pairs which are not connected to the power terminal can be coupled to the grounding terminal.

Accordingly, at least a portion of the anti-noise portion of the signal transmission unit in the line set can serve as a sub-carrier for the power signal. Thereby, the diameter of the power transmission unit can be reduced or maintained to mitigate the voltage drop and/or the energy attenuation of the transmission cable.

The foregoing disclosure is merely preferred embodiments of the present invention and is not intended to limit the claims of the present invention. Any equivalent technical variation of the description and drawings of the present invention of the present shall be within the scope of the claims of the present invention.

What is claimed is:

1. A transmission cable comprising:
a terminal connector including a circuit board and a setting head having a power terminal, a grounding terminal, and a first signal terminal; and
a line set including a signal transmission unit with a first signal transmission part and a drain wire, the first signal transmission part electrically coupled to the first signal terminal via the circuit board, and the drain wire electrically coupled to the power terminal via the circuit board.

2. The transmission cable of claim 1, wherein the circuit board has a first power pad and a first signal pad; a portion of the first signal transmission part is arranged on the first signal pad and electrically coupled to the power terminal; a portion of the drain wire is arranged on the first power pad and electrically connected to the first signal terminal.

3. The transmission cable of claim 2, wherein the line set further includes a power transmission unit, and the circuit board has a second power pad electrically connected to the power terminal; a portion of the power transmission unit is arranged on the second power pad.

4. The transmission cable of claim 1, wherein the line set further includes a power transmission unit electrically coupled to the power terminal via the circuit board.

5. The transmission cable of claim 1, wherein the line set further includes a shielding layer at least partly covering the signal transmission unit, and the shielding layer is electrically coupled to the grounding terminal.

6. The transmission cable of claim 1, wherein the signal transmission unit has a second signal transmission part electrically coupled to a second signal terminal of the setting head via the circuit board.

7. The transmission cable of claim 6, wherein the first signal transmission part and the second signal transmission part are a twisted pair configured to transmit a differential signal.

8. The transmission cable of claim 6, wherein the circuit board has a second signal pad electrically coupled to the second signal terminal, and a portion of the second signal transmission part is arranged on the second signal pad.

9. The transmission cable of claim 7, wherein the second signal pad is disposed of adjacent to the first signal pad.

10. A transmission cable comprising:
a terminal connector including a circuit board and a setting head having a power terminal, a grounding terminal, and a signal terminal; and
a line set including a signal transmission unit having a signal transmission part and a conductor layer, the signal transmission part electrically coupled to the signal terminal via the circuit board, the conductor layer at least partly covering the signal transmission part and electrically coupled to the power terminal.

11. The transmission cable of claim 10, wherein the circuit board has a first power pad and a signal pad; the first power pad is electrically coupled to the power terminal; the signal pad is electrically coupled to the signal terminal; a portion of the signal transmission part is arranged on the signal pad; a portion of the conductor layer is arranged on the first power pad.

12. The transmission cable of claim 11, wherein the line set further includes a power transmission unit; the circuit board further has a second power pad electrically coupled to the power terminal; a portion of the power transmission unit is arranged on the second power pad.

13. The transmission cable of claim 10, wherein the line set further includes a power transmission unit electrically coupled to the power terminal via the circuit board.

14. The transmission cable of claim 10, wherein the line set further includes a shielding layer at least partly covering the signal transmission unit, and the shielding layer is electrically coupled to the grounding terminal.

15. The transmission cable of claim 11, wherein the first power pad is arranged between the signal pad and a side of the circuit board adjacent to the line set.

16. A terminal connector comprising:
a setting head having a power terminal, a grounding terminal, and a signal terminal; and
a circuit board configured to connect the setting head and a line set, wherein the circuit board includes a first power pad configured to electrically couple an anti-noise part of the line set to the power terminal.

17. The terminal connector of claim 16, wherein the circuit board includes a signal pad configured to electrically couple the signal terminal; the signal pad is adjacent to the first power pad.

18. The terminal connector of claim 17, wherein the first power pad is arranged between the signal pad and a side of the circuit board away from the setting head.

19. The terminal connector of claim 16, wherein the circuit board includes a second power pad configured to electrically couple a power transmission unit of the line set to the power terminal.

20. The terminal connector of claim 16, wherein a specification of the setting head corresponds to one of HDMI, DP, and USB.
